(19) United States
(12) Patent Application Publication
(10) Pub. No.: US 2009/0141507 A1
(43) Pub. Date: Jun. 4, 2009

(54) LIGHTING FIXTURE CHANNEL WITH DIFFUSER

(76) Inventors: James P. Compton, Conyers, GA (US); William Wesley Herndon, Covington, GA (US); Yvon Laplante, Valcourt (CA); Jim Dumas, Leslie, GA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/326,688

(22) Filed: Dec. 2, 2008

Related U.S. Application Data
(60) Provisional application No. 61/005,201, filed on Dec. 3, 2007.

(51) Int. Cl. F21V 21/34

(52) U.S. Cl. 362/355

(57) ABSTRACT

Embodiments of this invention may include a lighting fixture having a channel provided with an integrally-formed structure for retaining a diffuser. According to one embodiment of the present invention, the end caps of a channel may include integrally formed retaining arms intended to abut and retain a diffuser located within the channel of the light fixture. Other embodiments of the invention provide interlocking structure for retaining the channel end caps in the desired position relative to the channel. According to one embodiment of the present invention, the end caps are secured to the channel body through a tab-slot connection. The slot and tab combination secure the end caps in a desired angle relative to the channel body.

### CROSS REFERENCE TO RELATED APPLICATIONS

This application claims priority to U.S. provisional application Ser. No. 61/005,201, entitled “Fluorescent Light Channel with Diffuser,” filed Dec. 3, 2007, the entire contents of which are hereby incorporated by this reference.

### FIELD OF INVENTION

Various aspects and embodiments of the present invention relate to providing a lighting fixture channel having integrally-formed means for retaining a diffuser within the channel.

### BACKGROUND OF INVENTION

Conventional fluorescent lighting fixtures 10, as shown in FIG. 1, include a channel 20 having a rectangular shape and a diffuser 30. The channel 20 houses, among other things, fluorescent lamps, lamp sockets, and a ballast. The diffuser 30 engages the channel 20 so that, when the channel 20 is positioned in, or suspended from, the ceiling, the internal components of the fixture 10 (e.g., lamps, ballast, wiring, etc.) are concealed by, and the emitted light is diffused as desired by, the diffuser 30.

The channel 20 is typically formed from a sheet metal blank that is folded to assume the rectangular shape as shown in FIG. 2. The channel 20 includes a planar channel body 22, end caps 24, and side walls 26. When the channel blank is formed into the channel 20, the end cap portions 24 are folded up so as to extend substantially orthogonal to the channel body 22. To retain the end caps 24 in that position, metal from the end caps 24 has traditionally been crimped 28 to the side walls 26 of the channel 20 as shown in FIG. 4. However, crimping does not positively lock the ends caps 24 into place relative to the channel 20; the crimped portions 28 of the end caps 24 and side walls 26 that hold each other together often work themselves loose. Thus, over time, insufficient crimping can result in movement of the position of the end cap 24 relative to the remainder of the channel 20 so that the end cap 24 is no longer orthogonal to the channel 20. Such movement, in turn, can jeopardize retention of the diffuser 30 within the channel 20.

The diffuser 30, as shown in FIG. 2, is typically formed of plastic and includes a diffuser body 32 having ends 34 and side walls 36. In use, the diffuser 30 is positioned within the channel 20 so that the diffuser side walls 36 are adjacent to, but between, the channel side walls 26, which thus prevent lateral movement of the diffuser 30 relative to the channel 20.

Insertion and removal of the diffuser 30 requires that the length of the diffuser 30 be less than that of the channel 20. Given this length differential, gaps exist between the ends 34 of the diffuser 30 and the channel end caps 24 when the diffuser 30 is positioned in the channel 20. Without structure to prevent movement of the diffuser 30, the diffuser 30 can disengage from the channel 20 and drop out of the channel 20. Therefore, it is desirable to prevent longitudinal movement of the diffuser 30 relative to the channel 20.

Traditional fixtures have included a separate retainer clip 40, as shown in FIG. 3, that is snapped into the channel end caps 24 (as shown in FIGS. 4 and 5) to fill the gaps between the ends 34 of the diffuser 30 and the end caps 24. A lip portion 42 extends from an upper portion of the clip 40. When the diffuser 30 is installed in the channel 20, the diffuser ends 34 abut the clip 40, and more specifically under the lip 42, as shown in FIG. 6. This abutment prevents the diffuser 30 from moving longitudinally relative to the channel 20. However, installation in the channel 20 of separate retainer clips leads to longer assembly time. Moreover, improper installation and/or positioning of the retainer clip in the fixture can compromise its ability to retain the diffuser within the channel. Additionally, the retainer clips 40 are often inconsistently manufactured, leading to inconsistencies in the profile of the clips 40, hindering the fit of the clip 40 within the end cap 24 of the channel 20.

Given the shortcomings discussed above, there is a need for means to more securely retain the end caps in position relative to a lighting fixture channel. Additionally, there is a need for better means of preventing the longitudinal movement of a diffuser within a light fixture.

### SUMMARY OF THE INVENTION

Embodiments of this invention may include a lighting fixture channel provided with an integrally-formed structure for retaining a diffuser. According to one embodiment of the present invention, the end caps of a channel may include integrally formed retaining arms intended to abut and retain a diffuser located within the channel of the light fixture.

Other embodiments of the invention provide interlocking structure for retaining the channel end caps in the desired position relative to the channel. According to one embodiment of the present invention, the end caps are secured to the channel body through a tab-slot connection. The slot and tab combination secure the end caps in a desired angle relative to the channel body.

### BRIEF DESCRIPTION OF THE DRAWINGS

FIG. 1 is a perspective view of a prior art lighting fixture.

FIG. 2 is an exploded view of the lighting fixture of FIG. 2.

FIG. 3 is a perspective view of a prior art retainer clip.

FIG. 4 is a fragmentary perspective view of the retainer clip of FIG. 3 positioned in the channel of FIG. 1.

FIG. 5 is another fragmentary perspective view of the retainer clip of FIG. 3 positioned in the channel of FIG. 1.

FIG. 6 is a fragmentary perspective view of the retainer clip of FIG. 3 retaining the diffuser of the lighting fixture of FIG. 1.

FIG. 7 is a perspective view of a lighting fixture channel according to one embodiment of this invention.

FIG. 8 is a plan view of one embodiment of a blank from which the channel of FIG. 7 can be formed.

FIG. 8A is an enlarged section taken at inset circle 8A in FIG. 8.

FIG. 9 is a plan view of another embodiment of a blank from which the channel of FIG. 7 can be formed.

FIG. 9A is an enlarged section taken at inset circle 9A in FIG. 9.

FIG. 10 is a fragmentary perspective view of a tab and slot configuration for retaining in position the channel end caps of a lighting fixture channel according to an embodiment of this invention.

FIG. 11 is a fragmentary perspective view of integral retention means provided on a channel end cap according to an embodiment of this invention.

FIG. 12 is a perspective view of the channel of FIG. 7 retaining a diffuser according to one embodiment of this invention.

### DETAILED DESCRIPTION

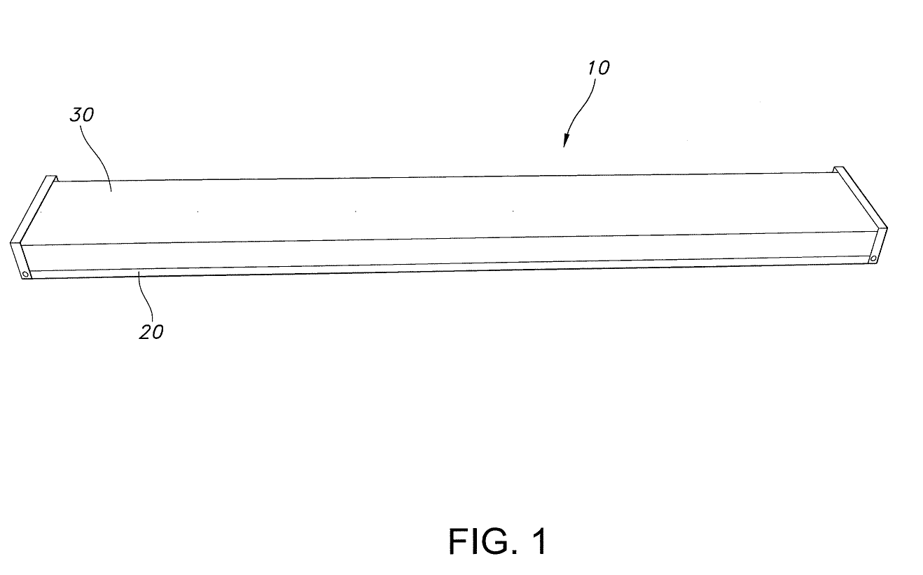

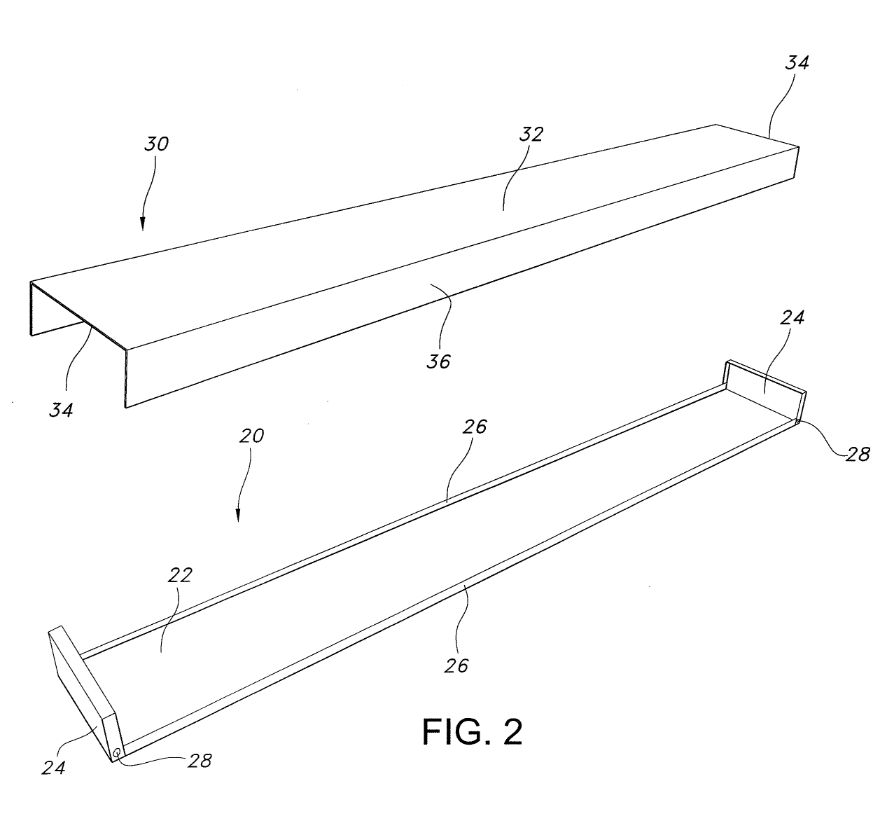

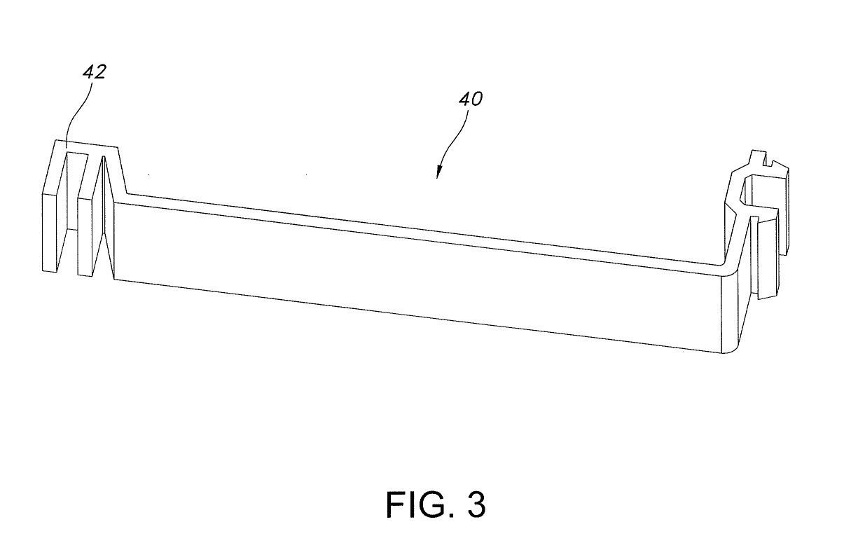

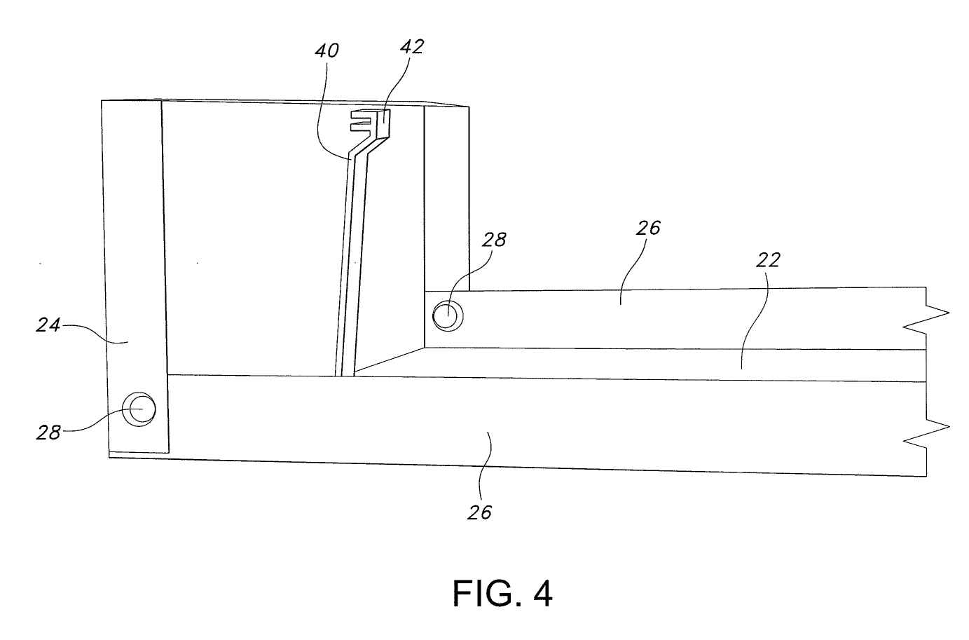

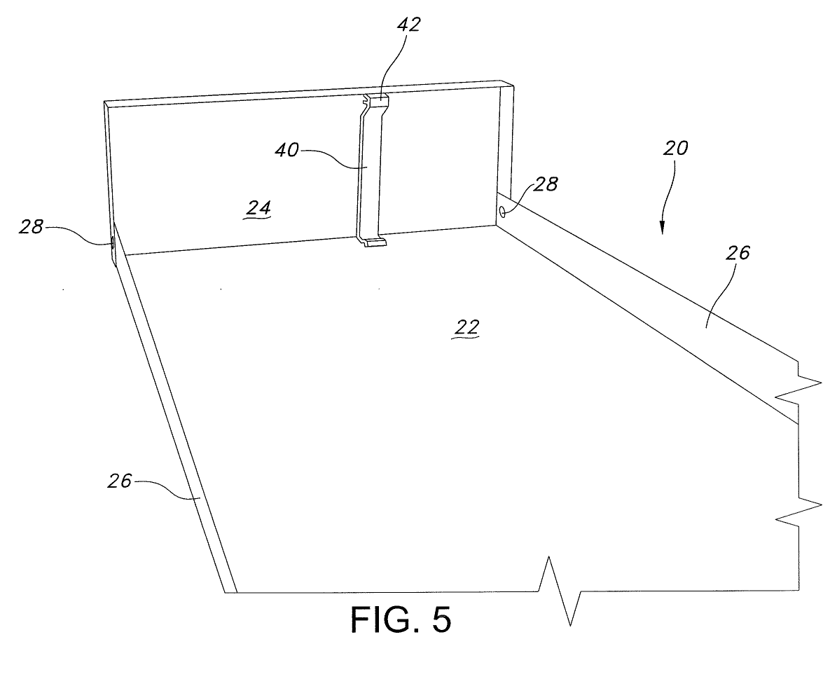

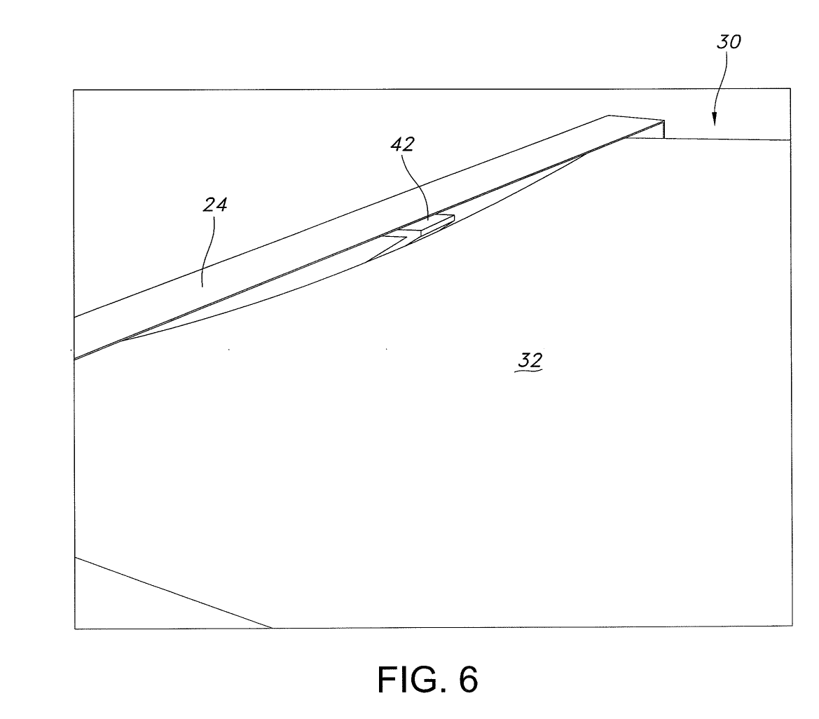

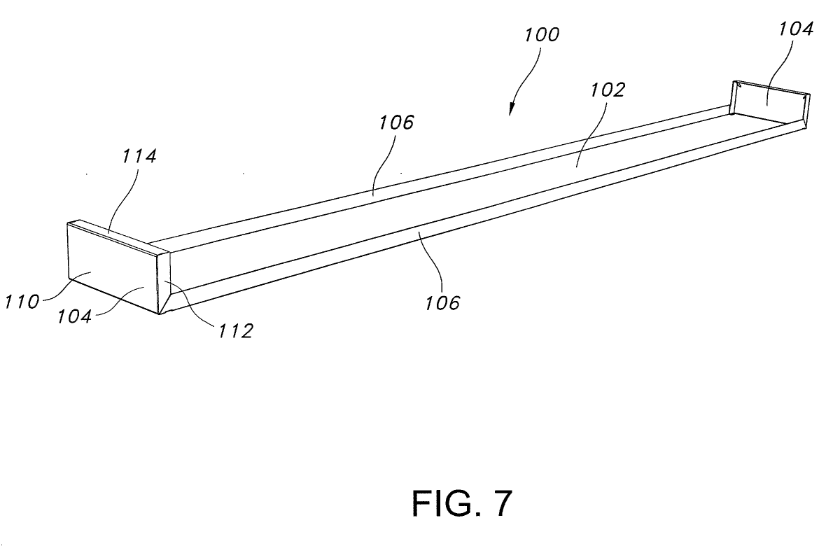

FIG. 7 illustrates a lighting fixture channel 100 according to one embodiment of the present invention. While the channel 100 may be any shape (including, but not limited to, rectangular, circular, oblong, triangular, square, etc.), FIG. 7 illustrates a rectangular channel 100 that, like the channel illustrated in FIG. 1, includes a planar channel body 102, channel end caps 104, and side walls 106. The channel end caps 104 include a base portion 110, side portions 112, and a top portion 114. The channel 100 may house various other components of the lighting fixture, including sockets, wiring, and a ballast and may include apertures that allow the fixture to be positioned in, or suspended from, the ceiling, as well as other openings that allow access to a power source.

The channel 100 may be formed from any material having suitable rigidity, strength, and other desirable properties, including, but not limited to, metal and plastic materials. Moreover, the channel components (channel body 102, channel end caps 104, and side walls 106) may be separate components that are attached together or alternatively may be integrally-formed.

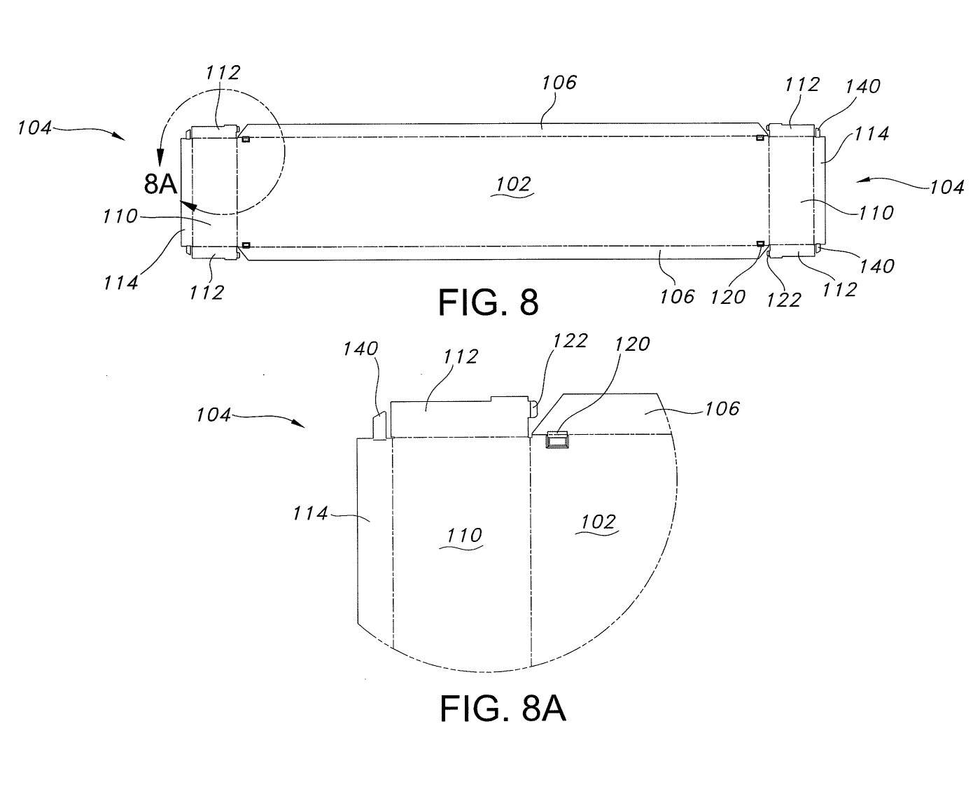

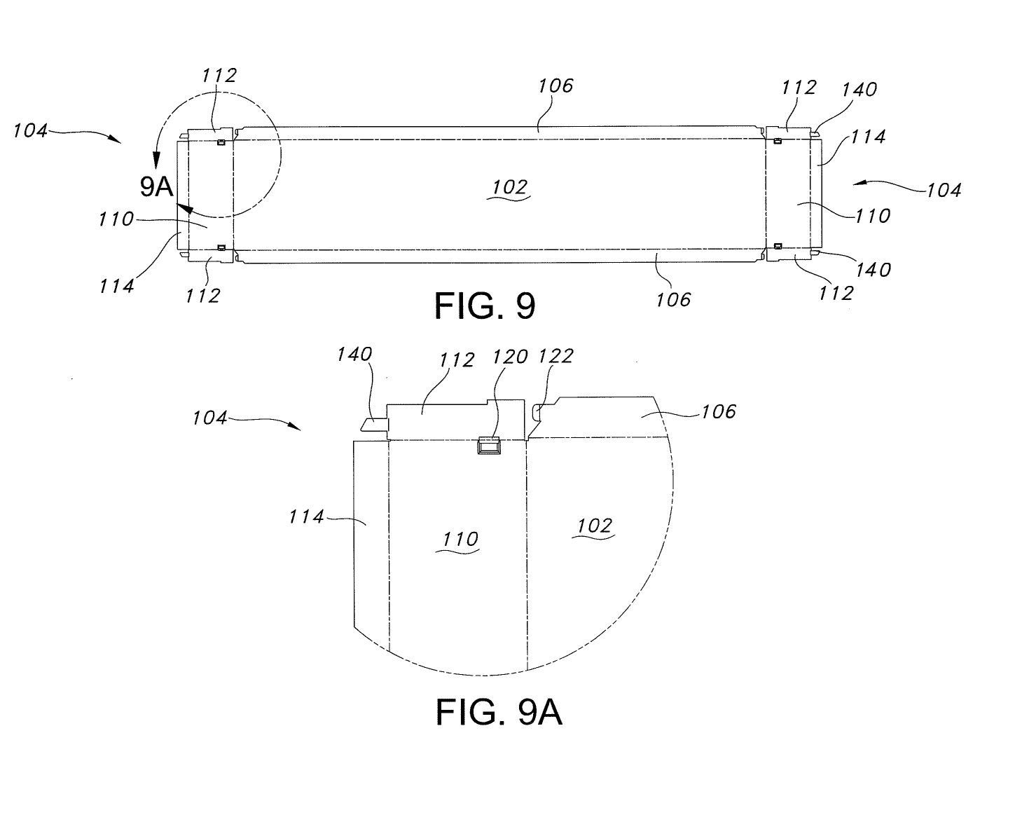

In the embodiments of channel 100 as shown in FIGS. 8, 8A, 9, and 9A, the channel components are integrally-formed from a sheet metal blank. To form the end caps 104, the side and top portions 112 and 114, respectfully, are folded upwards from the base portion 110 so as to extend substantially orthogonal to the base portion 110. The end caps 104 and side walls 106 are then folded upwardly from the body 102 so as to extend substantially orthogonal to the channel body 102. Various mechanical retention features (including crimping) may be used to secure the end caps 104 and side walls 106 in position relative to the remainder of the channel 100. In one embodiment, a slot and tab configuration is used. More specifically, a slot 120 may be provided in the base 102 and/or side walls 106 and an alignment tab 122 for engaging the slot 120 on one of the end caps 104, as illustrated by the blanks in FIGS. 8 and 8A. In other embodiments, the slot 120 may be provided on one of the end caps 104 and the alignment tab 122 on the base 102 or side walls 106, as shown in FIGS. 9 and 9A.

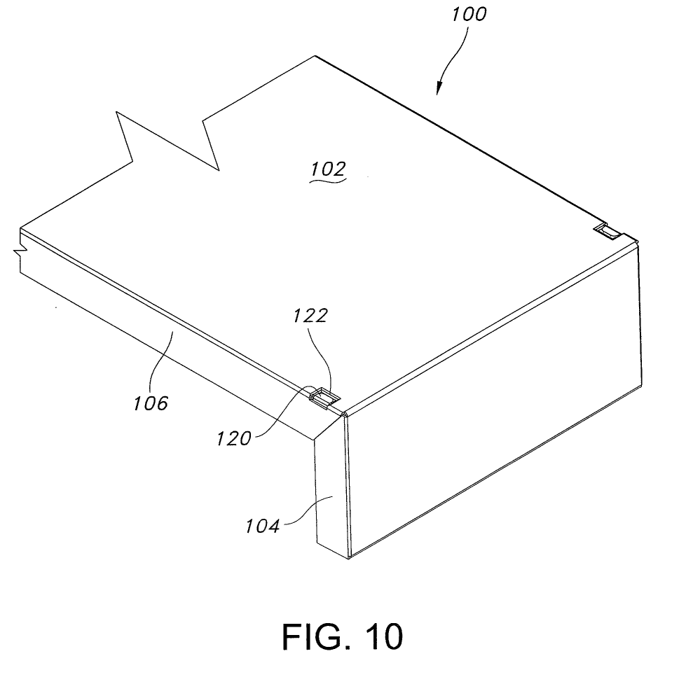

FIG. 10 illustrates a fragmentary view of the blank of FIGS. 8 and 8A folded to form the channel 100. In this embodiment, a slot 120 is provided at the junction of the channel base 102 and a side wall 106. An alignment tab 122 extends from the end cap 104 and more particularly from a side portion 112 of the end cap 104. When the end cap 104 is folded upward to the desired angle, the alignment tab 122 engages the slot 120 to retain the end cap 104 in the desired orientation, as shown in FIG. 10. Once the alignment tab 122 has engaged the slot 120, the tab 122 may be (but need not be) pressed substantially flush against the bottom surface of the channel body 102. It may be desirable, but not necessary, to provide indentations in the bottom surface of the channel body 102 for receiving the tabs 122 to ensure that the tabs 122 do not protrude from, but rather lie flush against, the channel body 102. The blank of FIGS. 9 and 9A is similarly formed into a channel, with the tab 122 located on the channel side wall 106 engaging the slot 120 in the end cap 104. One of skill in the art will understand that any number of alignment tabs 122 and slots 120 having any number of a variety of shapes may be positioned at any number of locations within the channel 100.

Use of the slot/tab configuration to secure the end cap 104 in position relative to the channel 100 improves upon traditional crimping. Unlike crimping, the slots and tabs positively engage, which results in a more reliable connection and reduces the risk of insufficient connection between the end caps 104 and channel body 102 during manufacture. It is unlikely that a tab will disengage a slot. Thus, the integrity of the connection is enhanced and the likelihood of an end cap moving relative to the channel body 102, and consequently the diffuser disengaging from the channel, is virtually eliminated. Moreover, the slot 120 and tab 122 combination produces a cleaner appearance for the channel 100.

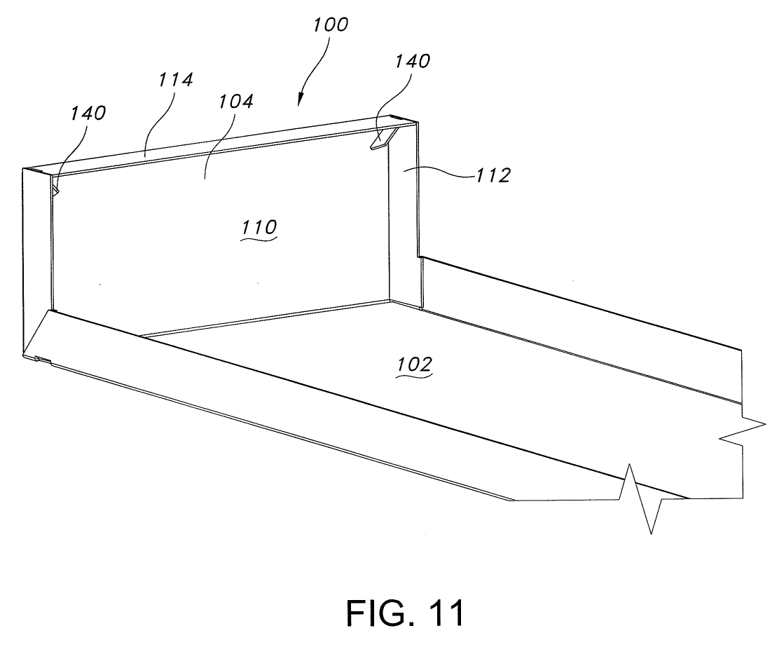

Embodiments of the channel 100 also include means to prevent substantial longitudinal movement of a diffuser 130 positioned within the channel 100. In one embodiment (see FIG. 11), at least one retention arm 140 is integrally-formed with, and extends from, an end cap 104 to prevent the longitudinal movement of the diffuser 130 within the channel 100.

Any number of retentions arms 140 may be positioned in any number of locations on an end cap 104. As shown in FIGS. 8, 8A, and 11, two retention arms 140 are formed integrally with the channel end cap 104 and more specifically extend inwardly and downwardly at an angle from the top portion 114 of the end cap 104. However, the retention arms may extend from any part of the end cap 104 (e.g., side portions 112, end wall 110, etc.). For example, in the embodiment of FIGS. 9 and 9A, the retention arms 140 are integrally-formed and extend from the side portions 112 of the end cap 104. Moreover, they may extend from the end cap 104 at any angle. While FIG. 11 illustrates the retaining arms 140 extending at an angle of approximately 45° relative to the channel body 102, they can extend anywhere between 0° to 90°. The retention arms, preferably, but not necessarily, have a depth so as not to extend beyond the side portions 112 and top portion 114 of the end cap 104. In this way, space is created within the end cap 104 for receiving and retaining an end of the diffuser. Additionally, in this way, when a diffuser is positioned within the channel, the retention arms 140 are concealed. The retention arms 140 may be placed in the corner of the end caps 104, where the side portions 112 and the top portion 114 work in tandem to further conceal the retention arms 104 upon positioning the diffuser within the channel 102. Retention arms 140 may also be, but do not have to be, provided on the opposing end cap 104.

In other embodiments, the retention arms 140 may be a separate piece that is attached to the end caps 104. While the retention arms 140 may be attached using mechanical retention means, a non-integral retention arm is a separate component, requiring separate installation. By integrally forming the retention arms 140 with the channel 100, the need to manufacture and install a separate component is eliminated. Also, any concerns relating to installation or retention of the arms 140 in the proper position and possible release of diffusers from channels are obviated.

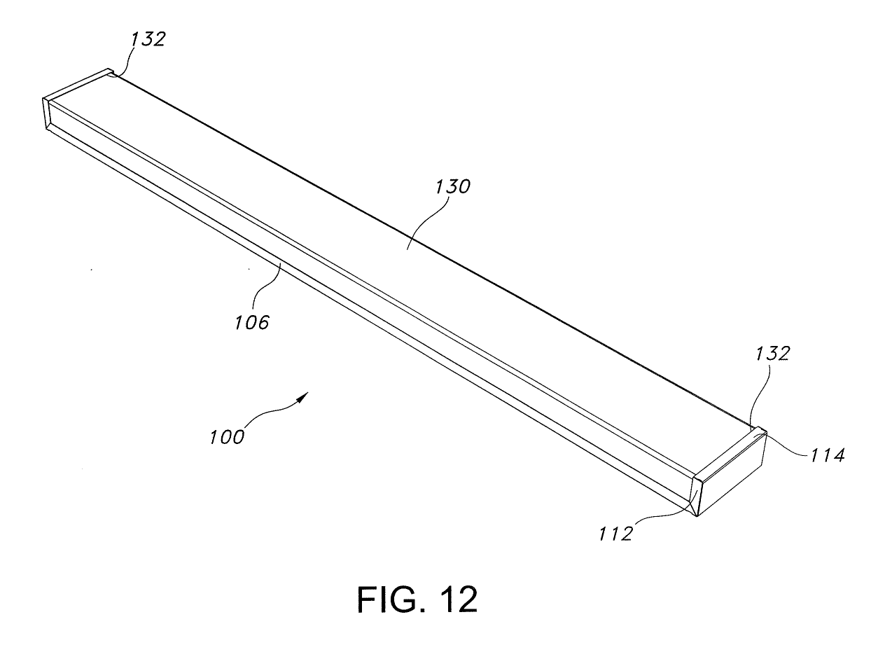

When a diffuser 130 is inserted into the channel 100, ends 132 of the diffuser 130 are positioned within the end caps 104. The side and top portions 112 and 114, respectfully, of the end caps 104 retain the diffuser 130 within the channel 100. The diffuser 130 is positioned within the channel 100 so that the diffuser side walls 136 are adjacent to, but between, the channel side walls 106, which thus prevent lateral movement of the diffuser 130 relative to the channel 100. The diffuser ends 132 abut the edges of the retention arms 140 (not shown), preventing the longitudinal movement of the diffuser 130 within the channel 100 as shown in FIG. 12.

The lighting fixture of this invention overcomes many disadvantages associated with other types of lighting fixtures currently in use. Modifications, adaptations, changes, deletions, and additions may be made to various embodiments of the invention as disclosed herein without departing from the scope or spirit of the invention or the following claims.

What is claimed is:

1. A lighting fixture comprising:
(a) a channel comprising:
(i) a base;
(ii) opposing sidewalls;
(iii) opposing first and second end caps; and
(iv) at least one retention arm integrally formed with the first end cap; and
(b) a diffuser comprising opposing ends,
wherein the diffuser is positioned in the channel so that at least one diffuser end abuts the at least one retention arm.

2. The lighting fixture of claim 1, wherein the first end cap further comprises a base portion, at least two side portions, and a top portion.

3. The lighting fixture of claim 2, wherein the at least one retention arm is integrally formed with and extends at an angle from the top portion of the first end cap.

4. The lighting fixture of claim 1, wherein the at least one retention arm comprises at least two retention arms.

5. The lighting fixture of claim 2, wherein the at least one retention arm is integrally formed with and extends at an angle from one of the at least two side portions of the first end cap.

6. The lighting fixture of claim 5, wherein the at least one retention arm comprises at least two retention arms, each retention arm integrally formed with one of the at least two side portions.

7. The lighting fixture of claim 1, wherein the base, opposing sidewalls, and first and second end caps are integrally formed.

8. The lighting fixture of claim 7, wherein the base, opposing sidewalls, and first and second end caps comprise metal.

9. The lighting fixture of claim 7, wherein the base, opposing sidewalls, and first and second end caps are integrally formed from a sheet metal blank.

10. The lighting fixture of claim 1, wherein the channel further comprises at least one tab and at least one slot for receiving the at least one tab to secure at least one of the first or second end cap at an angle relative to the channel base.

11. The lighting fixture of claim 10, wherein the at least one tab extends from at least one of the first or second end caps and the at least one slot is positioned in the base or one of the opposing side walls of the channel.

12. The lighting fixture of claim 11, wherein the first and second end caps each comprise at least two side portions and wherein the at least one tab is integrally formed with one of the at least two side portions.

13. The lighting fixture of claim 10, wherein the at least one slot is positioned in at least one of the first or second end caps and the at least one tab extends from the base or one of the opposing side walls of the channel.

14. The light fixture of claim 1, wherein the channel is substantially rectangular in shape.

15. The lighting fixture of claim 1, wherein the channel further comprises at least one retention arm integrally formed with the second end cap.

16. A lighting fixture comprising:
(a) a rectangular-shaped channel comprising:
(i) a base;
(ii) opposing sidewalls;
(iii) opposing first and second end caps, wherein each of the opposing first and second end caps comprises:
A. a base portion;
B. a top portion extending from the base portion;
C. at least two side portions extending from the base portion; and
D. at least one retention arm integrally formed with the top portion or at least one of the at least two side portions; and
(b) a diffuser comprising opposing ends and positioned in the channel so that each of the opposing ends of the diffuser abuts the at least one retention arm on the opposing first and second end caps.

17. A method of forming a lighting fixture including a light channel and a diffuser, comprising:
(a) forming a channel comprising:
(i) providing a sheet metal blank comprising a base and opposing ends;
(ii) forming the opposing ends of the sheet metal blank into end caps,
wherein at least one of the end caps comprises at least one integrally formed retention arm;
(iii) positioning the end caps at an angular position relative to the base; and
(iv) securing the end caps in the angular position; and
(b) positioning a diffuser having opposing ends within the channel such that at least one of the opposing ends of the diffuser abuts the at least one integrally formed retention arm.

18. The method of claim 17, wherein the sheet metal blank further comprises at least one tab and at least one slot and wherein securing the end caps comprises inserting the at least one tab into the at least one slot.

19. The method of claim 18, wherein the at least one end cap comprises the at least one tab.

20. The method of claim 18, wherein the at least one end cap comprises the at least one slot.
